(19) United States
(12) Patent Application Publication
(10) Pub. No.: US 2004/0184810 A1
(43) Pub. Date: Sep. 23, 2004

(54) Rate adaptive optical communication system and method thereof

(76) Inventors: Antony K. Spilman, Ipswich (GB); David G. Cunningham, Woodbridge (GB)

Correspondence Address: PERMAN & GREEN, 425 POST ROAD, FAIRFIELD, CT, 06824, US

(21) Appl. No.: 10/798,146

(22) Filed: Mar. 11, 2004

(30) Foreign Application Priority Data
Mar. 18, 2003 (GB) 0306087.8

(51) Int. Cl. H04B 10/00

(52) U.S. Cl. 398/139

(57) ABSTRACT

The present invention discloses a rate adaptive system for an optical communication network. The system comprises a plurality of optical transceivers capable of transmitting and receiving optical signals at a plurality of rates and an optical fibre linked to the transceivers. The system is configured to cause the optical transceivers to transmit and receive optical signals at an initial rate and to adapt the rate based upon an error condition.

The present invention relates to a method for adapting the transmission rate of an optical communication system so as to utilise the maximum possible transmission rate within that system.

Currently optical communication links are set up to operate at a fixed rate of transmission. This rate is determined by the foreseen distribution of bandwidths (per unit length), the lengths of the fibres in which the optical signals are transmitted, and the performance that can be economically specified for the optical interfaces. The worse cases of the above “link budgets” are generally based on the outside “tails” of wide distributions, so the typical (or average) performance that can be realised is often much higher. Current optical transceivers are capable of transmitting data at multiple rates, for example, at 1 Gb/s or 2.5 Gb/s. However, when transceivers are fitted into a given system, they are configured to operate at a transmission rate predetermined for that system. This rate will be set at the lowest rate that the entire installed base is capable of handling. For example, in a fibre network that has three lengths of fibre, two of which could handle transmission rates of 2.5 Gb/s and a third can only handle 1.0 Gb/s, the entire network will be configured to operate at 1.0 Gb/s. This has the negative effect of causing the entire network to operate at a slower speed than it may be capable of due to one bad link.

Current networks based on twisted pairs of copper wire, such as those disclosed in EP 0952700A” and, GB 2337672 and WO 99/13609 relate to 10-100 Mb/s Ethemets and require an auto-negotiation scheme to initialize the link. Auto-negotiation also provides a control channel for passing configuration and initialization data between both ends of the link. There is currently no auto-negotiation scheme for optical fibre LANs. In addition, auto-negotiation requires knowledge of the packet/frame/codeword structure. The present invention does not require auto-negotiation or a control channel.

Currently there is a vast network of installed optical fibre links of various lengths and bandwidth all of which are capable of handling a variety of transmission rates from a few Gb/s to as high as many 10 of Gb/s.

Installing a new network of optical components all capable of operating at a higher transmission rate, for example, 10 Gb/s across the wide installed base of performances, is not economically feasible in today's climate. Customers are not willing to upgrade these links because they “may” have a low bandwidth fiber

However, there is a desire to make better use of the existing fibre network by operating at the maximum speed a link is capable of, and not at the speed of the slowest link in the network.

The present invention aims to solve the above-mentioned problems by providing a method and system, which would allow the optical fibre link to change its line rate based on the performance characterisations of the link. Such an adaptive optical communication system would provide for more efficient use of the existing large installed base of legacy fibre optic cable, which has a wide distribution of performance in terms of the optical bandwidth per unit length and also the lengths of each cable.

Rate adaptive optics would enable a communication system to optimise it's performance to match the available fibre bandwidth and actual link length for a given path and therefore enable systems to statistically achieve greater throughput and or longer link distances than would be derived from a conventional optical link where the optics have been margined for the worst case link lengths and fibre bandwidth as described in common industry standards. This represents significant cost savings over conventional optical modules because the reduced performance extremes translate to lower cost optical technology.

Rate adaptive optics may allow applications to be addressed that are beyond the technical limits of a worst-case performance budget for mature technologies for all possible installed fibre bandwidths and link lengths at full data rates.

Rate adaptive optics may also give feedback of marginal fibre links to their owners without blocking the short-term installation and operation of a system, also allowing end users to identify such links for upgrade as a planned rather than reactive event.

According to the present invention there is provided a rate adaptive system for optical communication networks comprising a plurality of optical transceivers capable of transmitting and receiving optical signals at a plurality of rates, and an optical fibre linked to said optical transceivers, said system being configured to cause said optical transceivers to transmit and receive optical signals at an initial rate and to adapt said initial rate based upon an error condition.

The rate adaptive system can be embedded in the optical transceiver modules themselves.

Furthermore, there is provided a rate adaptive method for operating an optical communication network, the method comprising the step of transmitting data at an initial rate, receiving said data, evaluating said data to determine if an error condition exists, and adapting said rate based upon said evaluation.

While the principle features and advantages of the present invention have been described above, a greater understanding and appreciation will be gained by referring to the following figures and detailed description of the present invention, in which;

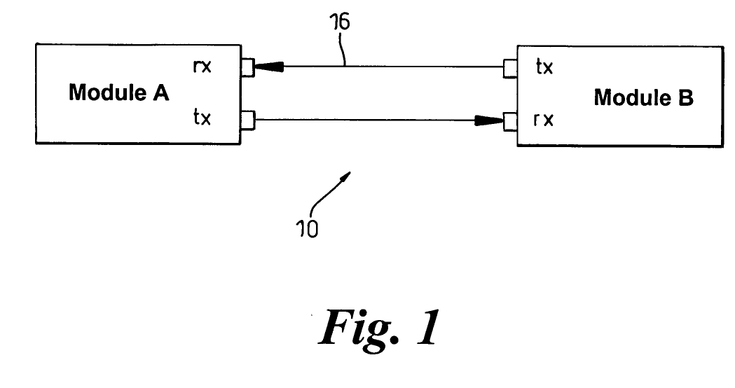

FIG. 1 shows a typical point-to-point optical link,

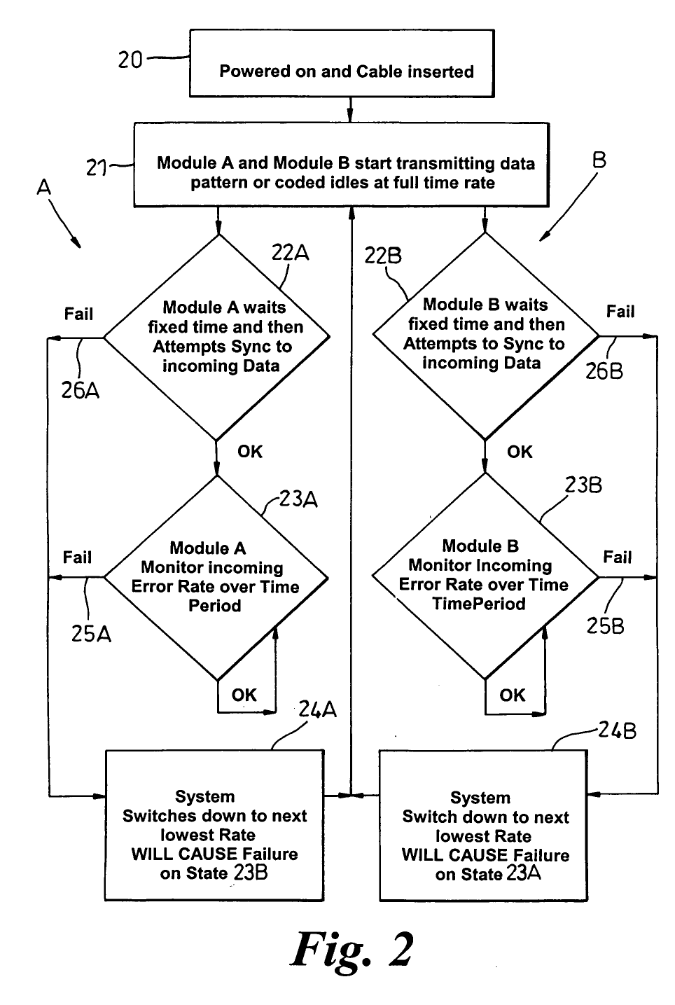

FIG. 2 shows operational flow chart of the adaptive optical system, and

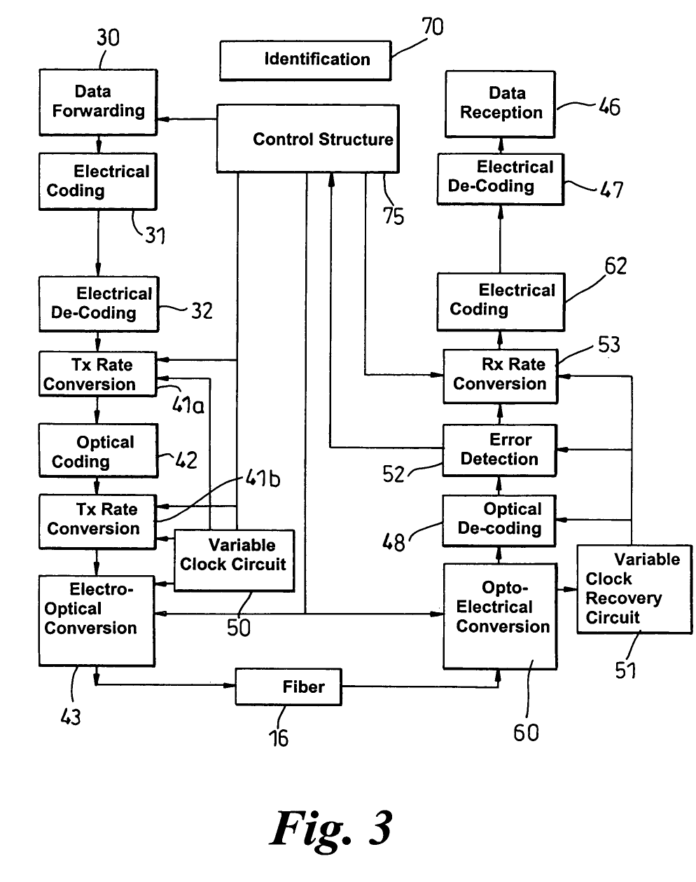

FIG. 3 shows a more detailed example of the adaptive optical system.

In FIG. 1 optical link 10 is shown comprising optical transceiver modules A and B linked together via optical fibre 16. Both modules are capable of transmitting and receiving optical signals to and from the fibre in a manner well known in the art. Both modules may even be capable of transmitting and receiving these signals at a variety of rates, for example 1 Gb/s, 2.5 Gb/s, 5.0 Gb/s, 7.5 Gb/s, and 10 Gb/s.

Typically, a communication network will consist of many such point-to-point links and the network will be configured to operate at the slowest of these links. So, even if fibre 16 is capable of carrying signals transmitted at 2.5 Gb/s, if a slower link (not shown) exists in the network that can only carry signals at 1.0 Gb/s, the entire network will be configured to operate at 1 Gb/s. Thus, in existing networks, modules A and B will either be pre-set to transmit and receive signals at 1 Gb/s, or be configured as such when they are connected to the network.

In FIG. 2 the basic steps envisioned to enable the transmission rate of an optical network to be adapted to utilise the maximum rate possible in each link are shown.

As a first step 20 the system is powered up and the fibre link 16 is plugged into modules A and B. Both modules will then start to transmit and receive data (step 21) at a predetermined rate, for example 10 Gb/s. After a predefined time period, both modules will attempt to synchronise to the incoming signal (steps 22A and 22B). If this is successful, both modules will continue to transmit data at 100% of the initial rate, in this example, 10 Gb/s. In addition, both modules will begin to monitor the incoming signal and calculate an error rate over a predetermined time period (steps 23A and 23B). If the error rate stays within a predefined range, for example <1 error in 10¹², the modules will continue to transmit and receive signals at 100% of the initial rate. However, if the error rate exceeds this predefined error range, FAIL signal 25A and/or 25B will be generated and the module will start to transmit data at the lower rate (steps 24A and/or 24B). For example, the module can be configured such that upon generation of a FAIL signal, the module begins to transmit data at 75% of the initial rate, in this example 7.5 Gb/s. Once module A starts to transmit at 7.5 Gb/s, module B, which was previously receiving data at 10 Gb/s will soon be unable to synchronise the incoming data (step 22B) and will generate FAIL signal 26B of its own. Module B will then move to step 24B and also start transmitting and receiving at the next lowest rate, which in this example is 7.5 Gb/s. If both modules are able to synchronise to the new incoming data being transmitted at 7.5 Gb/s (step 22A and 22B) the FAIL signals will be cleared and normal operation will continue, albeit at the new rate of 7.5 Gb/s. Error rate monitoring will recommence (steps 23A and 23B) and the link will be re-established.

If the modules are unable to synchronise at the new rate or a further FAIL signal is generated, the modules will attempt transmission at a further reduced rate, for example, 50% of the initial rate. In this example, the modules would attempt transmitting and receiving data at 5 Gb/s.

Further FAIL signals would cause further reductions in rates, down to a minimum rate of, for example, 1 Gb/s.

Failure to synchronise at this lowest rate would result in the link being shut down and the network operator being informed.

The network operator might also be informed of any reduction in rates so as to investigate the cause.

Advantageously, the system and method of the present invention allows the links to remain operational despite a need to reduce the transmission rates. Should synchronisation fail at the outset when the module transmits at 100% of its initial rate (26A, 26B), FAIL signal 26A and/or 26B will be generated before the link has even been established and a systematic switching down of rates will commence until synchronisation is achieved It should be obvious to those skilled in the art that error conditions other than synchronisation could be used for example: code word violations on the received optical signal or low received optical modulation amplitude (OMA).

FIG. 3 shows a more detailed embodiment of the rate adaptive system of the present invention. This further embodiment comprises a data-forwarding source 30 capable of adjusting the rate of data being forwarded per unit time over a large range in fixed increments. This adjustment may be by either slowing down the rate of it's outgoing interface 31, for example by adjusting the ratios of a Phase Lock Loop clock circuit or by padding the outgoing data with Non Valid data which can be identified and thrown away by a down stream process or by reducing the number of active channels filled with data if using a multi-channel parallel interconnect. A rate conversion block 41a and/or 41b can convert the data on the incoming interface 32 to a line rate of any of the fixed rate increments discussed above. The function of block 42 is to provide any line coding require for transmission over the optical fibre. This block must also strip off any padding if used as a mechanism by step 31 above. Block 43 converts the electrical signal to be transmitted into an optical signal, which would normally be done with a laser and appropriate drive electronics.

A circuit 50 is provided, which generates a precision, low jitter line rate clock at any of the above mentioned fixed rate increments for the transmit circuitry. A further circuit 51 is provided, which can recover a precision, low jitter line rate clock at any of the above mentioned fixed rate increments for the receive circuitry. Block 48 performs the inverse function of block 42. Circuit 52 is provided and functions to indicate errors from the data on the incoming link with a granularity such that it can be used to determine if the line rate should be reduced to a lower rate increment.

Rate conversion block 53 converts the data on the incoming interface 60 to the line rate of the upstream electrical interface 62. For the received information block 47 performs the same function as block 31. That is the rate of the upstream electrical interface 62 may be set by adjusting the ratios of a PLL or by padding the outgoing data with Non Valid data which can be identified and thrown away by an up stream process as per the outgoing interface 31. The data is electrical received by block 46 and is then passed on to higher layer protocols. Optionally, An identification mechanism 70 is provided, whereby another system that uses or interfaces to this adaptive communications system can identify it as such when the adaptive communications system introduced or connected to the system.

Control structure 75, which may be implemented in the host system, the adaptive communications system or a combination of both, is capable of the following:

a)—Reading error on the receiving link via 52 or a similar mechanism.

b)—Adjusting the rate at which data can be forwarded downstream.

c)—Adjusting the data rate of the transmit optical path, transmit rate conversion block and other related circuits to a slower increment rate.

d)—Adjusting of the rate at which the receiving optical path recovers clock and data, unless automatic.

e)—Adjusting the ratios of the receive rate conversion block and other related circuits to the appropiate electrical line rate.

f)—Adjusting the rate at which data can be received upstream.

g)—A control algorithm to make the above adjustments of protocols, optical technology, system time constants and other factors.

h)—Allow a host system to read-back information relating to the rate adaption ratios and setting used for a given optical link to assess the performance that the adapted link is obtaining.

1. A rate adaptive system for optical communication networks comprising:
a plurality of optical transceivers capable of transmitting and receiving optical signals at a plurality of rates,
an optical fibre linked to said optical transceivers,
wherein said system is configured to cause said optical transceivers to transmit and receive optical signals at an initial rate and to adapt said initial rate based upon an error condition.

2. A system as claimed in claim 1, wherein said error condition is a failure to synchronise a received signal.

3. A system as claimed in claim 1 or 2, wherein said system is further configured to calculate an error coefficient based on said received signals, and said error condition is said error coefficient exceeding a predefined range.

4. A system as claimed in any preceding claim, wherein said rate is lowered according to predefined percentages of said initial rate in response to said error condition.

5. A system as claimed in claim 4, wherein said percentages are 75, 50, and or 25 percent of said initial rate.

6. A system as claimed in any preceding claim, wherein said initial rate is 10 Gb/s.

7. A system as claimed in any preceding claim, wherein said system is configured to operate in an optical Ethernet network.

8. A system according to any preceding claim, wherein said system is further configured to notify a network operator in the event of said error condition.

9. A rate adaptive method for operating an optical communication network, the method comprising the step of:
transmitting data at an initial rate,
receiving said data,
evaluating said data to determine if an error condition exists, and
adapting said rate based upon said evaluation.

10. A method according to claim 9, wherein said step of adapting said rate comprises lowering said initial rate according to predefined percentages of said initial rate in response to said error condition.

11. A method according to claim 10, wherein said method comprises the further step of notifying a network operator in the event of said error condition.

12. An optical transceiver module for a rate adaptive system for optical communication networks comprising:
means for transmitting an optical signal via an optical fibre at a plurality of rates,
means for receiving an optical signal transmitted at a plurality of rates,
means for determining an error condition, and
means for adapting the optical signal transmission rate based upon the error condition.

13. A rate adaptive method for operating an optical communication networkd, the method comprising the step of:
transmitting test signals at an initial rate,
receiving said test signals,
evaluating said test signals to determine if an error condition exists,
and adapting said rate based upon said evaluation.
